(19) United States
(12) Patent Application Publication
(10) Pub. No.: US 2015/0143970 A1
(43) Pub. Date: May 28, 2015

(54) MICROTOME

(71) Applicant: MICROM INTERNATIONAL GMBH, Dreieich (DE)

(72) Inventor: Roland Johe, Eberbach (DE)

(21) Appl. No.: 14/405,967

(22) PCT Filed: May 14, 2013
(86) PCT No.: PCT/EP2013/001411

§ 371 Date: Dec. 5, 2014

(30) Foreign Application Priority Data
Jun. 6, 2012 (DE) 10 2012 011 201.7

(51) Int. Cl. G01N 1/06

(52) U.S. Cl. CPC G01N 1/06
USPC 83/821

(57) ABSTRACT

A microtome has a cutting device which is adjustably mounted on an arrangement of guide tracks. At least one electrical load, which is electrically connected to a current source, is provided on the cutting device. The current source is connected to the electrical load by the arrangement of guide tracks.

### CROSS REFERENCE TO RELATED APPLICATIONS

This application is a United States National Phase Application of International Application PCT/EP2013/001411 filed May 14, 2013 and claims the benefit of priority under 35 U.S.C. §119 of German Patent Application DE 10 2012 011 201.7 filed Jun. 6, 2012, the entire contents of which are incorporated herein by reference.

### FIELD OF THE INVENTION

The present invention pertains to a microtome with a cutting device, which is adjustably mounted on an array of guide tracks, whereby at least one electrical consumer which is electrically connected with a current source is provided at the cutting device.

### BACKGROUND OF THE INVENTION

Microtomes are used for cutting thin section preparations, in particular sensitive tissue specimens, which shall be investigated under the microscope. Microtomes usually have a cutting device with a replaceable knife or a blade as well as a specimen holder for a specimen to be cut.

Biological material is cured by means of fixing before cutting and then made cuttable by means of inserting in a liquid substance such as paraffin or synthetic resin, which cures transparently. The specimen is cut by means of the knife by the specimen sitting on the specimen holder being moved by means of a feed mechanism relative to the knife in order to obtain a continuous section through the specimen.

In order to integrate additional functions, for example, an illumination or an automated knife change in a knife holder, it is necessary to connect an electric energy supply. This is achieved by means of a connector plug in the state of the art. However, it frequently occurs that this connector plug is contaminated by paraffin residues and thus an electrical connection is no longer guaranteed. In addition, the current connector plug must be removed from the port or plugged in again each time when the knife holder is removed from the microtome. This results in additional manipulations and loss of time for a user.

### SUMMARY OF THE INVENTION

Therefore, a basic object of the present invention is to provide a microtome, in which an electrical consumer is automatically connected to an electric energy supply.

According to the invention, a microtome is provided with a cutting device, which is adjustably mounted on an array of guide tracks. At least one electrical consumer is electrically connected with a current source. The at least one electrical consumer is provided at the cutting device. The current source (10) is connected with the electrical consumer via the array of guide tracks. The array of guide tracks has at least two guide tracks running parallel to one another. A voltage difference can be applied between the at least two guide tracks.

The connection of an electrical consumer to a microtome according to the present invention is basically described in connection with same; however, the present invention is not limited thereto, since the present invention can also be used in other laboratory devices.

In particular, the present invention provides for the knife holder to be mounted as a supporting structure, especially via a bearing block on an array of guide tracks, which supporting structure is connected with the current source. The array of guide tracks may have at least two guide tracks, which run parallel to and at a distance from one another and project from the microtome forwards. The knife holder or the bearing block can be continuously adjusted along the guide tracks, whereby the knife holder or the bearing block is always in contact with the guide tracks.

In a preferred embodiment of the present invention, at least two guide tracks are provided, whereby a guide track each can be used as an electrical conductor. The guide tracks are made of metal to this end. Provisions may also be made for at least one electrical contact surface each being arranged on the at least two guide tracks. The contact surfaces on the guide tracks may be formed lengthwise along the surface or even be mounted on the sides depending on in which area the knife holder or the bearing block meshes with the guide tracks. In this case, the present invention provides that a contact area may be arranged at the knife holder or the bearing block, which may be in electrical contact with at least one of the guide tracks or their contact surfaces, when the knife holder or the bearing block is mounted. To this end, the knife holder or the bearing block may have electrical contacts on their contact surfaces with the guide tracks or be made of metal.

The present invention particularly preferably provides for the current supply to be guided via the guide tracks by a voltage difference, in particular a low voltage difference, prevailing between the guide tracks. This voltage difference may be used to supply at least one electrical consumer located at the cutting device. The voltage difference is correspondingly applied to the contact surfaces in the presence of defined contact surfaces on the guide tracks.

The electrical consumer may be, for example, an illuminating device and/or a cooling device and/or a heating device for the cutting device. Optionally, a drive for a safety strap or additional such devices may also be provided as electrical consumers at the microtome and in particular at the knife holder. Particularly preferably, the at least one electrical consumer may be integrated in the at least one knife holder. An arrangement in a different part of the microtome is also conceivable, e.g., a waste tray or a detachably connected deposit surface next to or below the cutting device.

Further, the present invention preferably provides for the current source to be arranged within the microtome and preferably to be part of a voltage power supply within the microtome. By the use of the internal voltage power supply, a compact construction is guaranteed, and no additional current connection is necessary for the at least one electrical consumer.

The current supply can preferably be used via the array of guide tracks for the connection of control elements for the electrical consumer as well. In this case, existing control elements may be used or new ones may be provided, which are connected with a control device of the microtome. A user no longer has to carry out additional manipulations, but rather can quickly and simply use the installed electrical consumers via the control device at the microtome.

Further details and features of the present invention appear from the following description of an exemplary embodiment with reference to the drawings

Further details and features of the present invention appear from the following description of an exemplary embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a microtome in accordance with the present invention; and

FIG. 2 is a schematic circuitry for a microtome in accordance with the present invention.

### DESCRIPTION OF THE PREFERRED EMBODIMENTS

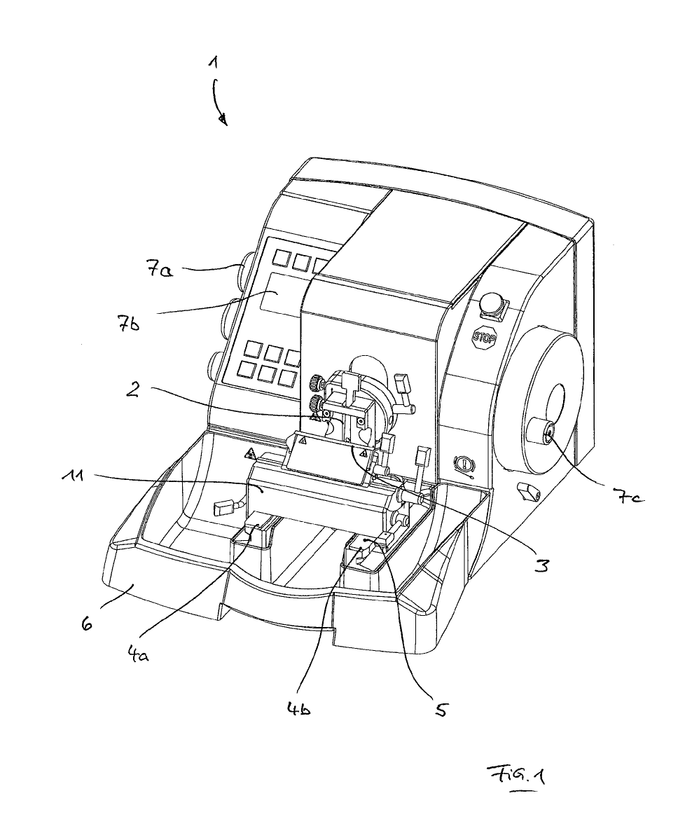

FIG. 1 shows a microtome 1 which has a cutting device with a specimen holder 2 and with a knife holder 3 arranged in front of it. The knife holder 3 is mounted on a bearing block 11, which sits on an array of guide tracks with two guide tracks 4a, 4b parallel to one another. The guide tracks 4a, 4b have electrical contact surfaces 5, with which the bearing block 11 is in electrical contact. In addition, electrical contacts can be arranged on the underside at the bearing block 11, and/or the bearing block 11 can be made of metal. The contact surfaces 5 on the guide tracks 4a, 4b are formed lengthwise along the surface. They may also be mounted on the sides depending on in which area the bearing block 11 meshes with the guide tracks 4a, 4b.

Further, a removable deposit device 6 with a waste tray is arranged at the microtome 1. Various control elements 7a, 7b, 7c, e.g., a plurality of adjusters and a display, make possible adjustments with regard to the specimen holder 7, the knife holder 3, as well as additional electrically connected parts at the microtome 1.

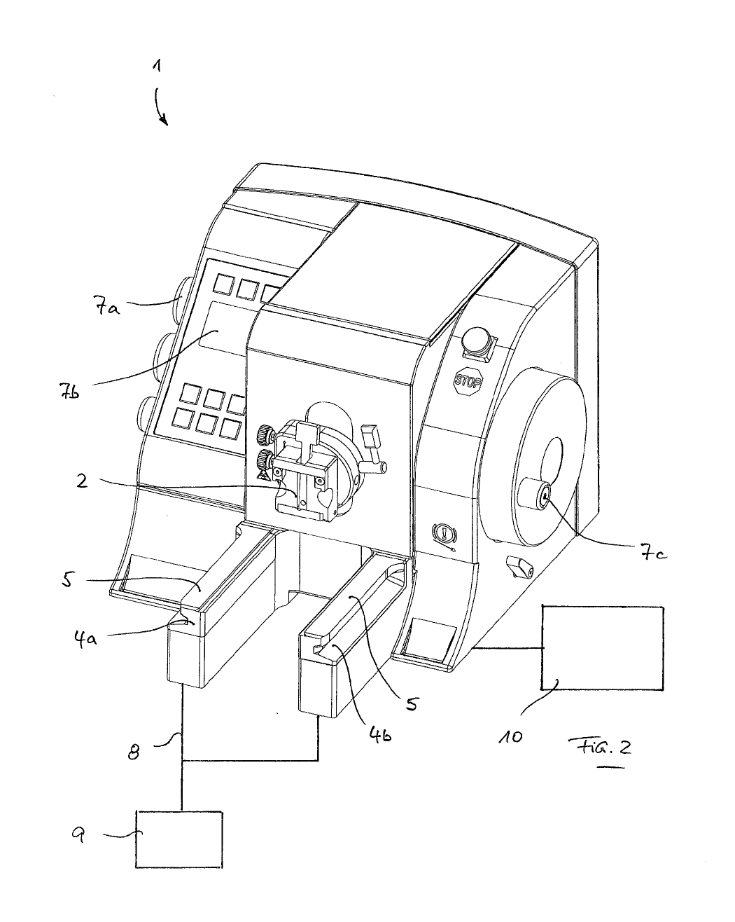

Furthermore, FIG. 2 shows a microtome 1 in accordance with the present invention in a schematic circuitry. The bearing block 11 with the knife holder 3 and the deposit device 6 are removed here for better clarity. The guide tracks 4a, 4b are electrically connected with an electrical consumer 9 by means of an electrical conductor 8, which is integrated in the knife block 11. Further, the guide tracks 4a, 4b are connected with a current source 10 in a microtome-internal circuitry. The electrical consumer 9 is thus electrically connected with the current source 10 via the guide tracks 4a, 4b. Furthermore, the current source 10 is connected with the control elements 7a, 7b, 7c, as a result of which the electrical consumer 9 can be controlled via the control elements 7a, 7b, 7c.

A voltage difference is applied to the guide tracks 4a, 4b by means of the current source 10. This is preferably a low voltage difference, whereby, for example, the voltage of 0 V is applied to the one guide track 4a and a voltage of approx. 5 V is applied to the other guide track 4b. The value of the applied voltage is measured depending on the electrical consumer 9 to be connected.

In this embodiment, the electrical consumer 9 is integrated in the bearing block 11 or knife holder 3. The knife holder 3 may have, for example, an integrated illumination as an electrical consumer 9. Such an illumination is connected via the electrical contact between the bearing block 11 and the guide tracks 4a, 4b at the circuit in the microtome 1 and thus at the current source 10. Cables to be additionally manually connected by the user, which supply an electrical consumer 9 with current, are no longer necessary. The supply of current is guaranteed via the guide tracks 4a, 4b alone. The electrical consumer 9 can, moreover, be controlled with the control elements 7a, 7b, 7c at the microtome 1. This makes the handling of the additional components at the microtome 1 easier.

While specific embodiments of the invention have been shown and described in detail to illustrate the application of the principles of the invention, it will be understood that the invention may be embodied otherwise without departing from such principles.

1. Microtome with a cutting device, which is adjustably mounted on an array of guide tracks (4a, 4b), whereby at least one electrical consumer (9), which is electrically connected with a current source (10), is provided at the cutting device, characterized in that the current source (10) is connected with the electrical consumer (9) via the array of guide tracks (4a, 4b).

2. Microtome in accordance with claim 1, characterized in that the array of guide tracks has at least two guide tracks (4a, 4b) running parallel to one another.

3. Microtome in accordance with claim 2, characterized in that at least one electrical contact surface (5) each is arranged on the at least two guide tracks (4a, 4b).

4. Microtome in accordance with claim 2 or 3, characterized in that a voltage difference can be applied between the at least two guide tracks (4a, 4b).

5. Microtome in accordance with one of the claims 1 through 4, characterized in that at least one contact area, which is in electrical contact with the guide tracks (4a, 4b), is arranged at the cutting device.

6. Microtome in accordance with one of the claims 1 through 5, characterized in that the at least one electrical consumer (9) is an illuminating device and/or a cooling device and/or a heating device and/or an electrically adjustable safety strap.

7. Microtome in accordance with one of the claims 1 through 6, characterized in that the cutting device has at least one specimen holder (2) and at least one knife holder (3).

8. Microtome in accordance with claim 6, characterized in that the at least one electrical consumer (9) is arranged in the at least one knife holder (3).

9. Microtome in accordance with one of the claims 1 through 8, characterized in that the current source is arranged within the microtome.

10. Microtome in accordance with claim 9, characterized in that the current source (10) is part of a voltage power supply within the microtome (1).
